(19) United States
(12) Patent Application Publication
(10) Pub. No.: US 2026/0018986 A1
(43) Pub. Date: Jan. 15, 2026

(54) SWITCHING CONVERTER WITH CURRENT SENSE CIRCUIT

(71) Applicant: Chengdu Monolithic Power Systems Co., Ltd., Chengdu (CN)

(72) Inventors: Rui He, Hangzhou (CN); Yuhang Sun, Hangzhou (CN); Lijie Jiang, Hangzhou (CN)

(21) Appl. No.: 19/270,411

(22) Filed: Jul. 15, 2025

(30) Foreign Application Priority Data
Jul. 15, 2024 (CN) CN202410946943.7

(51) Int. Cl. H02M 1/00; H02M 3/155

(52) U.S. Cl. CPC H02M 1/0048; H02M 1/0009; H02M 3/155

(57) ABSTRACT

A current sense circuit for a switching converter comprises a sensing capacitor, a sensing resistor, an adjusting resistor, a current mirror driving circuit, and a mirror current circuit. The sensing capacitor and the sensing resistor are coupled in series between two terminals of an inductor of the switching converter. A first terminal of the adjusting resistor is coupled to the current mirror driving circuit and the mirror current circuit, and a second terminal of the adjusting resistor is coupled to one terminal of the sensing capacitor. The current mirror driving circuit is further coupled to a common terminal formed by the sensing resistor and the other terminal of the sensing capacitor to provide a current driving signal by sensing a current flowing through the sensing resistor. The mirror current circuit receives the current driving signal and provides a current sensing signal based on a current flowing through the adjusting resistor.

### CROSS-REFERENCE TO RELATED APPLICATIONS

This application claims the benefit of CN application No. 202410946943.7, filed on Jul. 15, 2024, and incorporated herein by reference.

### BACKGROUND OF THE INVENTION

### 1. Field of the Invention

The present disclosure generally relates to electronic circuits, and more particularly, relates to switching converters.

### 2. Description of Related Art

A switching converter, also known as a switching power supply, is a high-performance power conversion device widely used for electronic equipment and power systems. The switching converter controls current flow by using switching devices to regulate power. The switching converters comprise Buck converters, Boost converter, etc., each of which have their advantages for specific applications. For example, Buck converters are suitable for providing an output voltage which is lower than the input voltage, while Boost converters are suitable for providing an output voltage which is higher than the input voltage. These switching converters play an important role in different applications, such as electric vehicle chargers, server power supplies, energy storage systems, etc.

In recent years, with the increasing requirements on efficiency and size of power supplies, the demand for smaller and more efficient switching converters with lower cost is also increasing.

### SUMMARY OF THE INVENTION

It is one of the objects of the present invention to provide a switching converter with current sense circuit, wherein switching converter has faster response and improved stability.

Embodiments of the present disclosure are directed to a switching converter, comprising an input voltage terminal capable of receiving an input voltage, an output voltage terminal capable of providing an output voltage, a first switching circuit, a first flying capacitor, a second switching circuit, a first inductor and a second inductor, a first current sense circuit, a second current sense circuit, and a controller. The first switching circuit comprises a first switch, a second switch and a third switch, each of the first switch, the second switch, and the third switch having a first terminal and a second terminal. The first terminal of the first switch is coupled to the input voltage terminal, the second terminal of the first switch is coupled to the first terminal of the second switch to form a first intermediate node, the second terminal of the second switch is coupled to the first terminal of the third switch to form a first switch node, and the second terminal of the third switch is coupled to a reference ground. The first flying capacitor has a first terminal and a second terminal, wherein the first terminal of the flying capacitor is coupled to the first intermediate node. The second switching circuit comprises a fourth switch having a first terminal and a second terminal. The first terminal of the fourth switch is coupled to the second terminal of the first flying capacitor, and the second terminal of the fourth switch is coupled to the reference ground. Each of the first inductor and the second inductor has a first terminal and a second terminal. The first terminal of the first inductor is coupled to the first switch node, the second terminal of the first inductor and the first terminal of the second inductor are coupled together and both coupled to the output voltage terminal, and the second terminal of the second inductor is coupled to the first terminal of the fourth switch. The second terminal of the first inductor and the first terminal of the second inductor are non-dotted terminals. The first current sense circuit is capable of providing a first current sensing signal based on a current flowing through the first inductor. The second current sense circuit is capable of providing a second current sensing signal based on a current flowing through the second inductor. The controller is capable of generating a droop voltage signal based on the first current sensing signal and the second current sensing signal, and providing a first switching control signal, a second switching control signal, a third switching control signal, and a fourth switching control signal respectively for controlling the first switch, the second switch, the third switch, and the fourth switch based on the first current sensing signal, the second current sensing signal, the output voltage, the droop voltage signal, and a reference signal.

Embodiments of the present disclosure are directed to a switching converter, comprising a first switching circuit, a second switching circuit, a first inductor and a second inductor negatively coupled with each other, a first current sense circuit, a second current sense circuit, and a controller. The controller comprises an output voltage sensing pin, an input voltage sensing pin, a first current sensing pin, a second current sensing pin, a first control signal output pin, a second control signal output pin, a third control signal output pin, a fourth control signal output pin, and a fifth control signal output pin, a sixth control signal output pin. The output voltage sensing pin is capable of receiving an output voltage sensing signal representing an output voltage of the switching converter. The input voltage sensing pin is capable of receiving an input voltage sensing signal representing an input voltage of the switching converter. The first current sensing pin is capable of receiving a first current sensing signal provided by the first current sense circuit, wherein the first current sensing signal represents a current flowing through the first inductor. The second current sensing pin is capable of receiving a second current sensing signal provided by the second current sense circuit, wherein the second current sensing signal represents a current flowing through the second inductor. The first control signal output pin is capable of providing a first switching control signal to control a first switch of the first switching circuit. The second control signal output pin is capable of providing a second switching control signal to control a second switch of the first switching circuit. The third control signal output pin is capable of providing a third switching control signal to control a third switch of the first switching circuit, wherein the first switch, the second switch, and the third switch are coupled in series between an input terminal for receiving the input voltage of the switching converter and a reference ground. The fourth control signal output pin is capable of providing a fourth switching control signal to control a fourth switch of the second switching circuit. The fifth control signal output pin is capable of providing a fifth switching control signal to control a fifth switch of the second switching circuit. The sixth control signal output pin is capable of providing a sixth switching control signal to control a sixth switch of the second switching circuit, wherein the fourth switch, the fifth switch, and the sixth switch are coupled in series between the input terminal of the switching converter and the reference ground. The first current sense circuit comprises a first sensing capacitor and a first sensing resistor coupled in series between the first terminal and the second terminal of the first inductor, and the second current sense circuit comprises a second sensing capacitor and a second sensing resistor coupled in series between the first terminal and the second terminal of the second inductor. The first current sense circuit is capable of generating a first current driving signal based on sensing a current flowing through the first sensing resistor and providing the first current sensing signal based on the first current driving signal, and the second current sense circuit is capable of generating a second current driving signal based on sensing a current flowing through the second sensing resistor and providing the second current sensing signal based on the second current driving signal. The controller is capable of turning on the first switch by adjusting the first switching control signal based on the output voltage and turning on the fifth switch by adjusting the fifth switching control signal based on the output voltage, wherein the first switch is turned off in response to that a time period of the first switch being on is equal to a first time period, and the fifth switch is turned off in response to that a time period of the fifth switch being on is equal to a second time period. The controller is further capable of adjusting the first time period and the second time period based on the input voltage, the first current sense signal, and the second current sense signal.

Embodiments of the present disclosure are directed to a current sense circuit for a switching converter, the switching converter having a switch and an inductor. The current sense circuit comprises a sensing capacitor and a sensing resistor coupled in series between a first terminal and a second terminal of the inductor, an adjusting resistor having a first terminal and a second terminal, a current mirror driving circuit, and a mirror current circuit. A first terminal of the sensing resistor and a first terminal of the sensing capacitor are coupled together to form a common terminal of the sensing resistor and the sensing capacitor. The current mirror driving circuit is coupled to the first terminal of the adjusting resistor and the common terminal of the sensing resistor and the sensing capacitor, and is capable of providing a current driving signal based on sensing a current flowing through the sensing resistor. The second terminal of the adjusting resistor is coupled to a second terminal of the sensing capacitor. The mirror current circuit is capable of receiving the current driving signal and providing a current sensing signal based on a current flowing through the adjusting resistor, wherein the first terminal of the adjusting resistor is further coupled to the mirror current circuit.

These and other features of the present disclosure will be readily apparent to persons of ordinary skill in the art upon reading the entirety of this disclosure, which includes the accompanying drawings and claims.

### BRIEF DESCRIPTION OF DRAWINGS

The present disclosure can be further understood with reference to the following detailed description and the appended drawings, wherein like elements are provided with like reference numerals.

FIG. 1 schematically shows a circuit diagram of a switching converter 100 in accordance with an embodiment of the present disclosure.

FIG. 2 schematically shows a circuit diagram of a current sense circuit 130 and a current sense circuit 140 of the switching converter 100 in accordance with an embodiment of the present disclosure.

FIG. 3 schematically shows a circuit diagram of a controller 150 of the switching converter 100 in accordance with an embodiment of the present disclosure.

FIG. 4 schematically shows a circuit diagram of an on-time circuit 154 of the switching converter 100 in accordance with an embodiment of the present disclosure.

FIG. 5 schematically shows a circuit diagram of a switching control circuit 155 of the switching converter 100 in accordance with an embodiment of the present disclosure.

FIG. 6A shows waveforms 10 of switching control signals generated by the controller 150 with a duty ratio D smaller than 0.5 in accordance with an embodiment of the present disclosure.

FIG. 6B shows waveforms 20 of the switching control signals generated by the controller 150 with the duty ratio D larger than 0.5 in accordance with an embodiment of the present disclosure.

FIG. 7 schematically shows a circuit diagram of a switching converter 200 in accordance with an embodiment of the present disclosure.

FIG. 8 schematically shows a circuit diagram of a current sense circuit 230 of the switching converter 200 in accordance with an embodiment of the present disclosure.

FIG. 9 schematically shows a circuit diagram of a controller 250 of the switching converter 200 in accordance with an embodiment of the present disclosure.

FIG. 10 schematically shows a circuit diagram of a switching control circuit 255 of the switching converter 200 in accordance with an embodiment of the present disclosure.

FIG. 11 shows waveforms 30 of the switching control signals generated by the controller 250 in accordance with an embodiment of the present disclosure.

FIG. 12 illustrates a current sense method 1000 for a switching converter in accordance with an embodiment of the present disclosure.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skills in the art that the present invention may be practiced without these specific details. In other instances, well-known methods, procedures, components, and circuits have not been described in detail so as not to unnecessarily obscure aspects of the present invention.

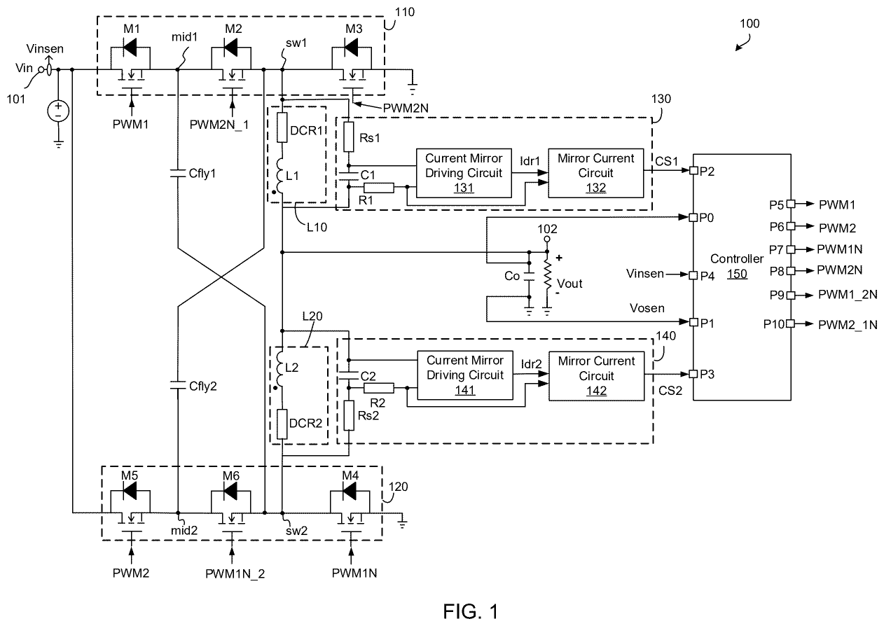

FIG. 1 schematically shows a circuit diagram of a switching converter 100 in accordance with an embodiment of the present disclosure. The switching converter 100 receives an input voltage Vin at an input voltage terminal 101 and provides an output voltage Vout at an output voltage terminal 102. The switching converter 100 comprises a switching circuit 110, a switching circuit 120, a flying capacitor Cfly1, a flying capacitor Cfly2, an inductor L10, an inductor L20, a current sense circuit 130, a current sense circuit 140, and a controller 150.

Each of the flying capacitors Cfly1-Cfly2 and the inductors L10-L20 has a first terminal and a second terminal. As shown in FIG. 1, the inductor L10 is shown in the form of an inductance value L1 and a direct current (DC) resistance DCR1 coupled in series. In another embodiment, the DC resistance DCR1 may also be a parasitic resistance of the inductor L10. Similarly, the inductor L20 shown in FIG. 1 is in the form of an inductance value L2 and a DC resistance DCR2 coupled in series, and in another embodiment, the DC resistance DCR2 may also be a parasitic resistance of the inductor L20. In one embodiment, the inductor L10 and the inductor L20 are negatively coupled (also referred to as reversely coupled) with each other, the second terminal of the inductor L10 and the first terminal of the inductor L20 are non-dotted terminals, and the inductor L10 and the inductor L20 are coupled together at their non-dotted terminals. The switching circuit 110 comprises a switch M1, a switch M2, and a switch M3, each of which has a first terminal and a second terminal. As shown in FIG. 1, the switches M1-M3 are coupled in series between the input voltage terminal 101 and a reference ground. In one embodiment, the first terminal of the switch M1 is coupled to the input voltage terminal 101, and the second terminal of the switch M1 and the first terminal of the switch M2 are coupled to form an intermediate node mid1. The second terminal of the switch M2 and the first terminal of the switch M3 are coupled to form a switch node sw1, and the second terminal of the switch M3 is coupled to the reference ground.

The switching circuit 120 comprises a switch M4, a switch M5, and a switch M6, each of which has a first terminal and a second terminal. The switches M5, M6, and M4 are coupled in series between the input voltage terminal 101 and the reference ground. In one embodiment, the first terminal of the switch M5 is coupled to the input voltage terminal 101, and the second terminal of the switch M5 and the first terminal of the switch M6 are coupled together to form an intermediate node mid2. The second terminal of the switch M6 and the first terminal of the switch M4 are coupled together to form a switch node sw2, and the second terminal of the switch M4 is coupled to the reference ground. The switches M1-M6 may comprise, for example, metal-oxide-semiconductor field-effect transistors (MOSFETs), junction field-effect transistors (JFETs), and other suitable transistors. In the example of FIG. 1, each of the switches M1-M6 is a MOSFET, the first terminal of each of the switches M1-M6 is a drain, and the second terminal of each of the switches M1-M6 is a source. In one embodiment, each of the switches M1-M6 further has a gate as a control terminal, which receives a corresponding driving signal based on a control scheme to control the switching converter 100 of FIG. 1 to generate the output voltage Vout.

The first terminal of the flying capacitor Cfly1 is coupled to the intermediate node mid1, and the second terminal of the flying capacitor Cfly1 is coupled to the first terminal of the switch M4. The first terminal of the flying capacitor Cfly2 is coupled to the intermediate node mid2, and the second terminal of the flying capacitor Cfly2 is coupled to the switch node sw1.

The first terminal of the inductor L10 is coupled to the switch node sw1, and the second terminal of the inductor L10 and the first terminal of the inductor L20 are both coupled to the output voltage terminal 102. The second terminal of the inductor L20 is coupled to the switch node sw2.

The current sense circuit 130 comprises a sensing capacitor C1, a sensing resistor Rs1, an adjusting resistor R1, a current mirror driving circuit 131, and a mirror current circuit 132. The sensing capacitor C1 and the sensing resistor Rs1 are coupled in series to form an RC circuit, which is coupled between the first terminal and the second terminal of the inductor L10. Each of the sensing capacitor C1, the sensing resistor Rs1, and the adjusting resistor R1 has a first terminal and a second terminal, wherein the first terminal of the sensing resistor Rs1 and the first terminal of the sensing capacitor C1 are coupled together to form a common terminal of the sensing resistor Rs1 and the sensing capacitor C1. The second terminal of the sensing resistor Rs1 is coupled to the switch node sw1, the second terminal of the sensing capacitor C1 is coupled to the output voltage terminal 102, the first terminal of the adjusting resistor R1 is coupled to the current mirror driving circuit 131 and the mirror current circuit 132, and the second terminal of the adjusting resistor R1 is coupled to the second terminal of the sensing capacitor C1. The current mirror driving circuit 131 senses a current flowing through the sensing resistor Rs1 and provides a current driving signal Idr1, and the mirror current circuit 132 receives the current driving signal Idr1 and provides a current sensing signal CS1 based on a current flowing through the adjusting resistor R1. The current sensing signal CS1 represents a current flowing through the DC resistance DCR1 of the inductor L10. Similarly, the current sense circuit 140 comprises a sensing capacitor C2, a sensing resistor Rs2, an adjusting resistor R2, a current mirror driving circuit 141, and a mirror current circuit 142. The sensing capacitor C2 and the sensing resistor Rs2 are coupled in series between the first terminal and the second terminal of the inductor L20. Each of the sensing capacitor C2, the sensing resistor Rs2, and the adjusting resistor R2 has a first terminal and a second terminal, wherein the first terminal of the sensing resistor Rs2 and the first terminal of the sensing capacitor C2 are coupled together to form a common terminal of the sensing resistor Rs2 and the sensing capacitor C2. The second terminal of the sensing capacitor C2 is coupled to the output voltage terminal 102, the second terminal of the sensing resistor Rs2 is coupled to the second switch node sw2, the first terminal of the adjusting resistor R2 is coupled to the current mirror driving circuit 141 and the mirror current circuit 142, and the second terminal of the adjusting resistor R2 is coupled to the first terminal of the sensing capacitor C2. The current mirror driving circuit 141 senses a current flowing through the sensing resistor Rs2 and provides a current driving signal Idr2, and the mirror current circuit 142 receives the current driving signal Idr2 and provides a current sensing signal CS2 based on a current flowing through the adjusting resistor R2. The current sensing signal CS2 represents a current flowing through the DC resistance DCR2 of the inductor L20.

The controller 150 comprises a remote return pin P0, an output voltage sensing pin P1, a current sensing pin P2, a current sensing pin P3, an input voltage sensing pin P4, and control signal output pins P5-P10. The remote return pin P0 and the output voltage sensing pin P1 work together for remote sensing of the output voltage Vout. The output voltage sensing pin P1 is configured to receive an output voltage sensing signal Vosen representing the output voltage Vout of the switching converter 100. In one embodiment, the output voltage sensing pin P1 is coupled to one terminal of an output capacitor Co, the remote return pin P0 is coupled to the other terminal of the output capacitor Co, and a voltage between the output voltage sensing pin P1 and the remote return pin P0 is the output voltage sensing signal Vosen. The current sensing pin P2 receives a current sensing signal CS1, the current sensing pin P3 receives a current sensing signal CS2, the input voltage sensing pin P4 receives an input voltage sensing signal Vinsen representing the input voltage Vin, the control signal output pin P5 provides a switching control signal PWM1, the control signal output pin P6 provides a switching control signal PWM2, the control signal output pin P7 provides a switching control signal PWM1N, the control signal output pin P8 provides a switching control signal PWM2N, the control signal output pin P9 provides a switching control signal PWM1_2N, and the control signal output pin P10 provides a switching control signal PWM2_1N.

In one embodiment, the switching control signal PWM1 is configured to turn on and off the switch M1, the switching control signal PWM2 is configured to turn on and off the switch M5, the switching control signal PWM2N_1 is configured to turn on and off the switch M2, the switching control signal PWM1N_2 is configured to turn on and off the switch M6, the switching control signal PWM2N is configured to turn on and off the switch M3, and the switching control signal PWM1N is configured to turn on and off the switch M4.

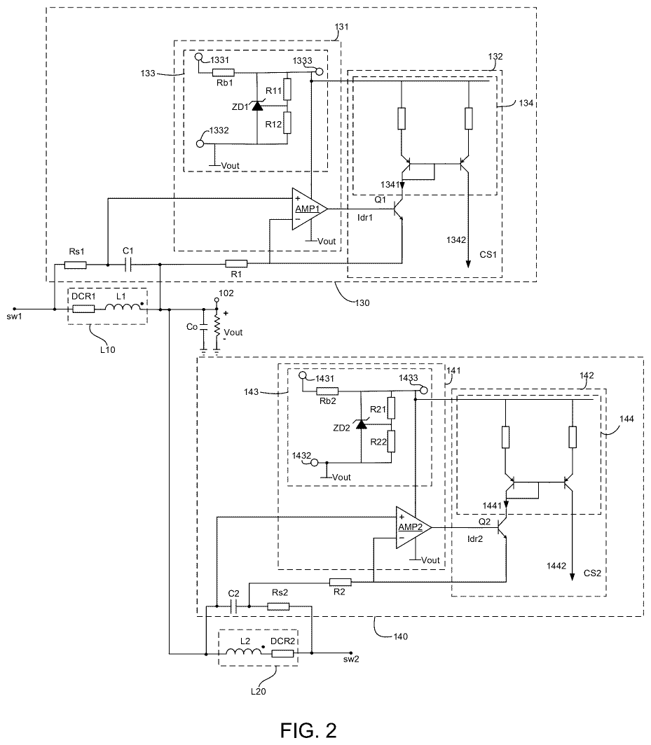

FIG. 2 schematically shows a circuit diagram of the current sense circuit 130 and the current sense circuit 140 of the switching converter 100 in accordance with an embodiment of the present disclosure. The current sense circuit 130 comprises the sensing capacitor C1, the sensing resistor Rs1, the adjusting resistor R1, the current mirror driving circuit 131 and the mirror current circuit 132, the current mirror driving circuit 131 being coupled to the common terminal of the sensing resistor Rs1 and the sensing capacitor C1 and the first terminal of the adjusting resistor R1. Similarly, the current sense circuit 140 comprises the sensing capacitor C2, the sensing resistor Rs2, the adjusting resistor R2, the current mirror driving circuit 141 and the mirror current circuit 142, the current mirror driving circuit 141 being coupled to the common terminal of the sensing resistor Rs2 and the sensing capacitor C2 and the first terminal of the adjusting resistor R2. In the embodiment of FIG. 2, the current mirror driving circuit 131 comprises an operational amplifier AMP1. In the embodiment of FIG. 2, the current mirror driving circuit 131 further comprises a voltage regulation circuit 133 for supplying power to the operational amplifier AMP1. One with ordinary skill in the art should understand that circuits used for supplying power to the operational amplifier AMP1 are not limited by the example of FIG. 2. The voltage regulation circuit 133 comprises, for example, a voltage input terminal 1331, a voltage input terminal 1332 and a voltage output terminal 1333, wherein the voltage output terminal 1333 is coupled to a positive power supply terminal of the operational amplifier AMP1 to supply power to the operational amplifier AMP1. The mirror current circuit 132 comprises a transistor Q1 and a current mirror 134. The current mirror 134 has an input terminal coupled to the voltage regulation circuit 133, a first terminal 1341, and a second terminal 1342. In one embodiment, the transistor Q1 comprises, for example, a bipolar junction transistor (BJT) or other suitable current-driven transistor. The transistor Q1 has a control terminal, a first terminal and a second terminal. In one embodiment, the control terminal of the transistor Q1 may be a base, the first terminal of the transistor Q1 may be a collector, and the second terminal of the transistor Q1 may be an emitter. Similarly, in the embodiment of FIG. 2, the current mirror driving circuit 141 comprises an operational amplifier AMP2, and the current mirror driving circuit 141 may further comprise a voltage regulation circuit 143 for supplying power to the operational amplifier AMP2. In the embodiment of FIG. 2, the voltage regulation circuit 143 comprises, for example, a voltage input terminal 1431, a voltage input terminal 1432 and a voltage output terminal 1433, wherein the voltage output terminal 1433 is coupled to a positive power supply terminal of the operational amplifier AMP2 to supply power to the operational amplifier AMP2. One with ordinary skill in the art should understand that circuits used for supplying power to the operational amplifier AMP2 are not limited by the example of FIG. 2, and in another embodiment, the voltage regulation circuit 143 for supplying power to the operational amplifier AMP2 may not be included in the current sense circuit 140, while the voltage regulation circuit 133 is shared by the current sense circuit 130 and the current sense circuit 140. For example, a positive power supply terminal of the operational amplifier AMP2 and an input terminal of the current mirror 144 are both coupled to the voltage output terminal 1333 of the voltage regulation circuit 133. The mirror current circuit 142 comprises a transistor Q2 and a current mirror 144. The current mirror 144 has an input terminal coupled to the voltage regulation circuit 143, a first terminal 1441, and a second terminal 1442. In one embodiment, the transistor Q2 may also comprise, for example, a BJT, or other suitable current-driven transistor. The transistor Q2 has a control terminal, a first terminal, and a second terminal. In one embodiment, the control terminal of the transistor Q2 may be a base, the first terminal may be a collector, and the second terminal may be an emitter.

Generation of the current sensing signals CS1 and CS2 is described below by taking the current sense circuit 130 as an example since the current sensing signal CS1 and the current sensing signal CS2 are respectively generated by the current sense circuit 130 and the current sense circuit 140 in the same way.

The first terminal of the adjusting resistor R1 is coupled to an inverting input terminal of the operational amplifier AMP1 and the emitter of the transistor Q1, and the second terminal of the adjusting resistor R1 is coupled to the second terminal of the sensing capacitor C1.

The positive power supply terminal of the operational amplifier AMP1 is coupled to the voltage output terminal 1333 of the voltage regulation circuit 133 to receive a first voltage, and a negative power supply terminal is coupled to the output voltage terminal 102 (not shown in FIG. 2) to receive the output voltage Vout. One with ordinary skill in the art should understand that other circuits may also be used to supply power to the positive power supply terminal of the operational amplifier AMP1 to maintain a voltage difference between the positive power supply terminal and the negative power supply terminal of the operational amplifier AMP1. In addition, a non-inverting input terminal of the operational amplifier AMP1 is coupled to the common terminal of the sensing capacitor C1 and the sensing resistor Rs1, and the inverting input terminal of the operational amplifier AMP1 is coupled to the first terminal of the adjusting resistor R1 and the emitter of the transistor Q1. It should be noted that the sensing capacitor C1 and the sensing resistor Rs1 in the current sense circuit 130 are arranged in an order different from that of the sensing capacitor C2 and the sensing resistor Rs2 in the current sense circuit 140, because one of the first terminal and the second terminal of the sensing capacitors C1 and C2 must be directly coupled to the output voltage terminal 102. In the current sense circuit 140, the non-inverting input terminal of the operational amplifier AMP2 is coupled to the second terminal of the sensing capacitor C2, the inverting input terminal of the operational amplifier AMP2 is coupled to the first terminal of the adjusting resistor R2, and the second terminal of the adjusting resistor R2 is coupled to the common terminal of the sensing capacitor C2 and the sensing resistor Rs2. The operational amplifier AMP1 senses the current flowing through the sensing resistor Rs1 and generates the current driving signal Idr1, and then provides the current driving signal Idr1 from an output terminal of the operational amplifier AMP1 to the base of the transistor Q1. The current driving signal Idr1 is configured to drive the transistor Q1 so that the transistor Q1 works in a linear amplification region. In one embodiment, low common-mode voltage operational amplifiers can be utilized since the operational amplifiers AMP1 and AMP2 outputs current signals, thereby reducing cost and size of the products.

The collector of the transistor Q1 is coupled to the first terminal 1341 of the current mirror 134, the emitter of the transistor Q1 is coupled to the inverting input terminal of the operational amplifier AMP1 and the first terminal of the adjusting resistor R1, and the base of the transistor Q1 is coupled to the output terminal of the operational amplifier AMP1 to receive the current driving signal Idr1 generated by the current mirror driving circuit 131, and thus works in the linear amplification region.

The input terminal of the current mirror 134 is coupled to the voltage output terminal 1333 of the voltage regulation circuit 133. The first terminal 1341 of the current mirror 134 is coupled to the collector of the transistor Q1, and the second terminal 1342 of the current mirror 134 is coupled to the first current sensing pin P2. The current mirror 134 is driven by the voltage provided by the voltage output terminal 1333 of the voltage regulation circuit 133. After receiving the current driving signal Idr1 at the base of the transistor Q1, a current flowing through the first terminal 1342 of the current mirror 134 is equal to a current flowing through the adjusting resistor R1. The current mirror 134 provides a mirror current as the current sensing signal CS1 to the current sensing pin P2 at its second terminal 1342 based on a current flowing through the first terminal 1341. The current sensing signal CS1 represents the current flowing through the DC resistance DCR1 of the inductor L10. Similarly, the current sensing signal CS2 represents the current flowing through the DC resistance DCR2 of the inductor L20.

In the embodiment of FIG. 2, the voltage regulation circuit 133 comprises a balancing resistor Rb1, voltage dividing resistors R11, R12, and a Zener diode ZD1, each of which has a first terminal and a second terminal. The voltage regulation circuit 133 receives the input voltage Vin from the voltage input terminal 1331, receives the output voltage Vout from the voltage input terminal 1332, and outputs a first voltage from the voltage output terminal 1333 after adjusting the output voltage Vout by using the balancing resistor Rb1, the voltage dividing resistors R11, R12, and the Zener diode ZD1. The first terminal of the balancing resistor Rb1 is coupled to the input voltage terminal 1331, and the second terminal of the balancing resistor Rb1 is coupled to the voltage output terminal 1333. The first terminal of the voltage dividing resistor R11 is coupled to the voltage output terminal 1333, and the second terminal of the voltage dividing resistor R11 is coupled to the first terminal of the voltage dividing resistor R12 and forms an intermediate node, which is coupled to a reference terminal of the Zener diode ZD1. The second terminal of the voltage dividing resistor R12 is coupled to the voltage input terminal 1332. An cathode terminal of the Zener diode ZD1 is coupled to the second output terminal 1333, and an anode terminal of the Zener diode ZD1 is coupled to the first output terminal 1332. By adjusting the resistance ratio of the voltage dividing resistor R11 and the voltage dividing resistor R12, the voltage output terminal 1333 can output any voltage level within a range of 2.5 V-36 V.

In one embodiment, the first voltage is higher than the output voltage Vout, and a voltage difference between the first voltage and the output voltage Vout is marked as a regulated voltage difference Vre, e.g., the regulated voltage difference Vre is equal to but not limited to 5V. A difference between the regulated voltage difference Vre and a maximum pin voltage (i.e., a maximum withstand voltage of the pins) of the controller 150 is smaller than 2V. The voltage output terminal 1333 of the voltage regulation circuit 133 is further coupled to the input terminal of the current mirror 134 to supply power to the current mirror 134. The voltage output terminal 1333 of the voltage regulation circuit 133 is coupled to the positive power supply terminal of the operational amplifier AMP1 to supply power to the positive power supply terminal of the operational amplifier AMP1, and maintain a voltage difference between the positive power supply terminal and the negative power supply terminal of the operational amplifier AMP1. Since the negative power supply terminal of the operational amplifier AMP1 receives the output voltage Vout, the voltage difference between the positive power supply terminal and the negative power supply terminal of the operational amplifier AMP1 is the voltage difference between the first voltage and the output voltage Vout. Therefore, the difference between the voltage difference between the positive power supply terminal and the negative power supply terminal of the operational amplifier AMP1 and the maximum withstand voltage of the pin of the controller 150 is smaller than 2V.

Similarly to the current sense circuit 130, in the current sense circuit 140, the operational amplifier AMP2, which is supplied by the voltage regulation circuit 143 and the output voltage terminal 102, senses the current flowing through the sensing resistor Rs2 and generates a current driving signal Idr2, and the current driving signal Idr2 is provided to the base of the transistor Q2. The transistor Q2 receives the current driving signal Idr2 and operates in the linear amplification region, so that the current mirror 144 provides a mirror current as the current sensing signal CS2 according to the current flowing through the adjusting resistor R2.

Taking the current sense circuit 130 in one embodiment of the present disclosure as an example, due to the virtual short and virtual open characteristics of the operational amplifier AMP1, the voltage V across the adjusting resistor R1, the adjusting resistor R1, the DC resistance DCR1 of the inductor L10, the current iL flowing through the DC resistance DCR1 of the inductor L10, and the current sensing signal CS1 satisfy the relation illustrated in the following formula (1). Although the current sense circuit 130 is taken as an example here, one with ordinary skills in the art should understand that the current sense circuit 130 here may also be equally replaced by the current sense circuits in other embodiments of the present disclosure.

$$CS 1 = V R 1 / R 1 = i {L}^{*} D C R 1 / R 1 \qquad ( 1 )$$

Therefore, the current gain CSgain=DCR1/R1 of the circuit can be used to represent the current flowing through the DC resistance DCR1 of the inductor L10 by the current sensing signal CS1. In the embodiment of FIG. 2, since the input terminals of the operational amplifier AMP1 can be equivalent to open circuits, the current flowing through the adjusting resistor R1 is accurately sampled without being affected by the peripheral circuit. Therefore, the stability of the system is improved, and the accurate current sensing makes the control of the switches much more stable, thereby accelerating the response of the system.

In the prior art, inductor DC resistance (DCR) sensing is usually to sample a voltage across the sensing capacitor and thus generates a voltage sensing signal, and the voltage sensing signal is further converted into a current sensing signal for calculating the current flowing through the DC resistance of the inductor. However, in real operation, since the DC resistance of the inductor is usually very small (for example, 0.1 mΩ), the voltage sensing signal is easily disturbed by external circuits, and the voltage sensing signal may also be affected by a voltage drop caused by long conductive traces. In contrast, instead of converting the voltage sensing signal into the current sensing signal, the current sense method according to one embodiment of the present disclosure obtains the current flowing through the DC resistance of the inductor by directly sensing the current flowing through the regulation resistor, and thus has the advantage of not being affected by noise caused by the switches or circuit layout. Besides, since all the components in the current sense circuit are composed of analog elements, the current sense circuit has a very large bandwidth to respond to high-frequency current signals.

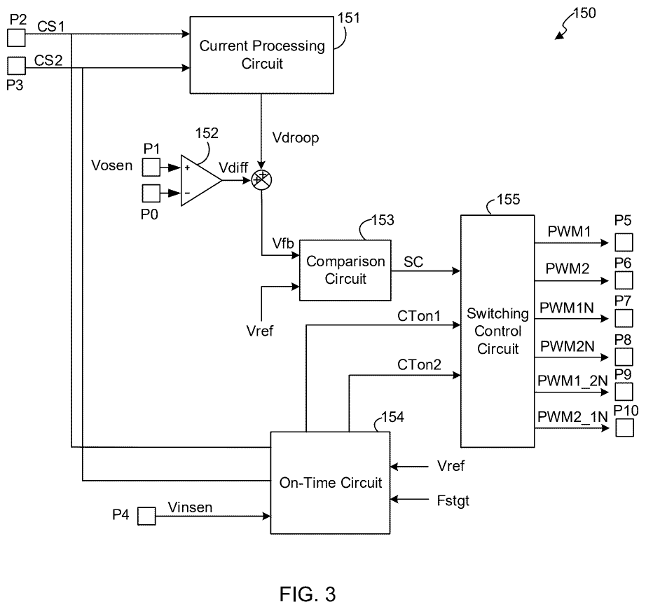

FIG. 3 schematically shows a circuit diagram of the controller 150 of the switching converter 100 in accordance with an embodiment of the present disclosure. As shown in FIG. 3, the controller 150 comprises a current processing circuit 151, a differential amplifier 152, a comparison circuit 153, an on-time circuit 154, and a switching control circuit 155. According to one embodiment of the present disclosure, the controller 150 generates a droop voltage signal Vdroop based on the current sensing signal CS1 and the current sensing signal CS2, and provides the plurality of switching control signals for controlling the switches M1-M6 based on the current sensing signal CS1, the current sensing signal CS2, the output voltage Vout, the droop voltage signal Vdroop, and a reference signal Vref.

The current processing circuit 151 receives the current sensing signal CS1 from the current sensing pin P2 and the current sensing signal CS2 from the current sensing pin P3. After summing (i.e., adding) the current sensing signal CS1 and the current sensing signal CS2, the current processing circuit 151 modulates the sum of the current sensing signal CS1 and the current sensing signal CS2 with a specific proportion to obtain a droop current signal Idroop, and then converts the modulation result into the droop voltage signal Vdroop. The droop voltage signal Vdroop represents a voltage drop that needs to be formed on the output voltage Vout when an output current of the switching converter 100 increases.

The differential amplifier 152 has two terminals coupled to the output voltage sensing pin P1 and the remote return pin P0 to receive the output voltage sensing signal Vosen, and the differential amplifier 152 provides a differential signal Vdiff after differential amplification. The controller 150 provides a voltage feedback signal Vfb based on the differential signal Vdiff, for example, the voltage feedback signal Vfb is equal to a sum of the differential signal Vdiff and the droop voltage signal Vdroop (i.e., Vdiff+Vdroop).

The comparison circuit 153 provides a comparison signal SC based on a voltage feedback signal Vfb representing the output voltage Vout and a reference signal Vref. In one embodiment, the controller 150 provides the voltage feedback signal Vfb based on the output voltage sensing signal Vosen. In one embodiment, the comparison signal SC becomes high when the voltage feedback signal Vfb is smaller than the reference signal Vref. The reference signal Vref may be set based on a target value of the output voltage Vout, for example, through a pin of the controller 150, or based on initial data stored in the controller 150, or by a user through a communication bus, etc.

The on-time circuit 154 provides on-time control signals CTon1, CTon2 based on the input voltage sensing signal Vinsen, the current sensing signals CS1, CS2, the reference signal Vref, and a target frequency signal Fstgt. The on-time control signal CTon1 is configured to control a time period Ton1 of the switching control signal PWM1 being in a first state, and the on-time control signal CTon2 being used to control a time period Ton2 of the switching control signal PWM2 being in the first state.

The target frequency signal Fstgt represents a target value of the switching frequency fs of the switching converter 100, for example, a desired value of the switching frequency fs of the switches M1-M6 when the switching converter 100 is operated in a steady state. The target frequency signal Fstgt may be set through a pin of the controller 150, or based on initial data stored in the controller 150, or by a user through a communication bus, etc. In one embodiment, the on-time circuit 154 controls the time periods Ton1 and Ton2 to vary with changes of at least one of the input voltage Vin, the reference signal Vref (i.e., the target value of the output voltage Vout), and the target frequency signal Fstgt (i.e., the target value of the switching frequency fs), and further adjusts at least one of the time periods Ton1 and Ton2 based on the current sensing signal CS1 and the current sensing signal CS2.

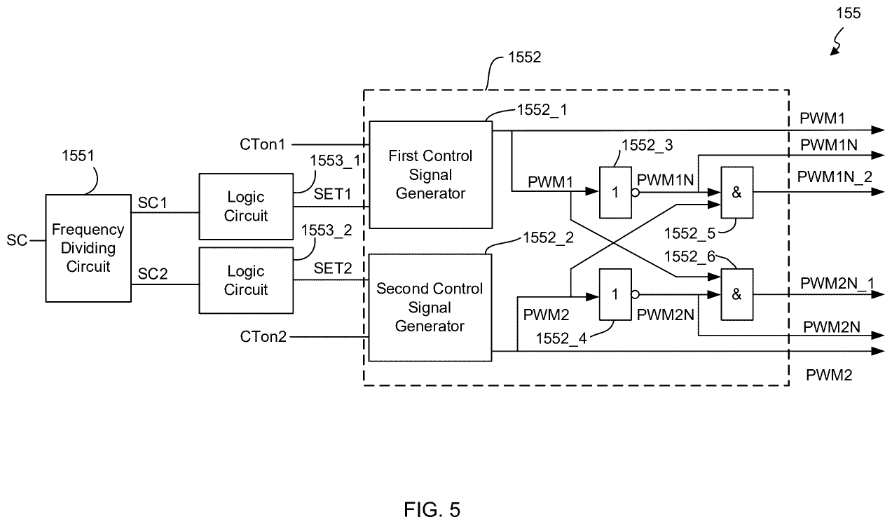

The switching control circuit 155 generates the switching control signals PWM1, PWM2, PWM1N, PWM2N, PWM1_2N, PWM2_1N based on the comparison signal SC and the on-time control signals CTon1, CTon2. In one embodiment, the switching control circuit 155 adjusts the switching control signal PWM1 based on at least one of the comparison signal SC and the on-time control signal CTon1 to control the switch M1 to switch between the first state and a second state, for example, the switch M1 is turned on when the switch M4 is kept off, and the switch M1 is turned off after a time period of the switch M1 being on is equal to the time period Ton1. The switching control circuit 155 adjusts the switching control signal PWM2 based on at least one of the comparison signal SC and the on-time control signal CTon2 to control the switch M5 to switch between the first state and the second state, for example, the switch M5 is turned on when the switch M3 is kept off, and the switch M5 is turned off after a time period of the switch M5 being on is equal to the time period Ton2. The switching control circuit 155 provides the switching control signals PWM1N, PWM2N, PWM1_2N, PWM2_1N based on the switching control signals PWM1, PWM2 by adjusting the switching control signals PWM1, PWM2. Specifically, the generation and adjustment of the switching control signals PWM1, PWM2, PWM1N, PWM2N, PWM1_2N, PWM2_1N by the switching control circuit 155 will be further described below with reference to FIG. 5.

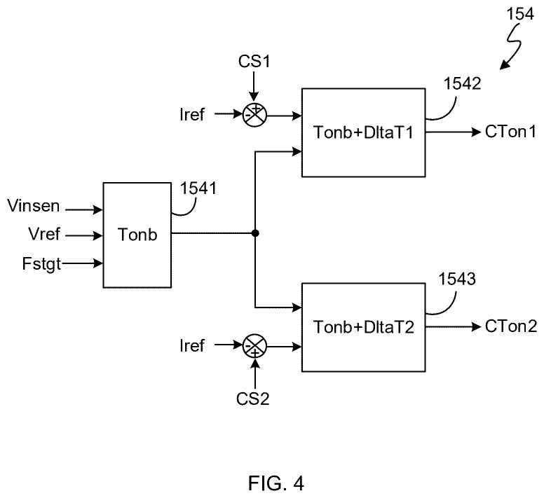

FIG. 4 schematically shows a circuit diagram of the on-time circuit 154 of the switching converter 100 in accordance with an embodiment of the present disclosure. The on-time circuit 154 comprises a calculation circuit 1541, an adjusting circuit 1542, and an adjusting circuit 1544. The adjusting circuit 1542 generates an adjusting time period DltaT1 based on a difference between the current sensing signal CS1 and the current reference signal Iref (i.e., CS1-Iref), and provides the on-time control signal CTon1 based on a sum of a basic time period Tonb and the adjusting time period DItaT1 (i.e., Tonb+DItaT1) to control the time period Ton1. The adjusting circuit 1544 generates an adjusting time period DItaT2 based on a difference between the current sensing signal CS2 and the current reference signal Iref (i.e., CS2-Iref), and provides the on-time control signal CTon2 based on a sum of the basic time period Tonb and the adjusting time period DltaT2 (i.e., Tonb+DItaT2) to control the time period Ton2. In one embodiment, the current reference signal Iref may be equal to an average value of the current sensing signal CS1 and the current sensing signal CS2, e.g., (CS1+CS2)/2, or equal to a preset value.

The basic time period Tonb is generated by the on-time circuit 154 based on the input voltage sensing signal Vinsen, the reference signal Vref, and the target frequency signal Fstgt, and is configured to control the time period Ton1 and the time period Ton2. In one embodiment, the basic time period Tonb is given in the following equation (2), and k is a scaling factor.

$$Tonb = \frac{k * V ref}{( V i n - k * V ref ) Fstgt} \qquad ( 2 )$$

FIG. 5 schematically shows a circuit diagram of the switching control circuit 155 of the switching converter 100 in accordance with an embodiment of the present disclosure. In the embodiment of FIG. 5, the switching control circuit 155 comprises a frequency dividing circuit 1551, a control signal generation circuit 1552, and logic circuits 1553_1 and 1553_2.

The frequency dividing circuit 1551 provides frequency dividing signals SC1 and SC2 based on the comparison signal SC. In one embodiment, the frequency dividing circuit 1551 distributes pulses of the comparison signal SC to the frequency dividing signal SC1 and the frequency dividing signal SC2 in turn. The logic circuit 1553_1 provides a set signal SET1 based on the frequency dividing signal SC1 to switch the switching control signal PWM1 to its first state. The logic circuit 1553_2 provides a set signal SET2 based on the frequency dividing signal SC2 to switch the switching control signal PWM2 to its first state.

The control signal generation circuit 1552 comprises a first control signal generator 1552_1 and a second control signal generator 1552_2. The first control signal generator 1552_1 generates the control signal PWM1 for controlling the switch M1 based on the frequency dividing signal SC1 and the on-time control signal CTon1, and the second control signal generator 1552_2 generates the control signal PWM2 for controlling the switch M5 based on the frequency dividing signal SC2 and the on-time control signal CTon2. Then the control signal PWM2N_1 for controlling the switch M2, the control signal PWM2N for controlling the switch M3, the control signal PWM1N for controlling the switch M4, and the control signal PWM1N_2 for controlling the switch M6 are generated based on the control signals PWM1 and PWM2 according to the control logic shown in FIG. 5. In one embodiment, the first control signal generator 1552_1 generates the switching control signal PWM1 based on the set signal SET1 and the on-time control signal CTon1. The second control signal generator 1552_2 generates the switching control signal PWM2 based on the set signal SET2 and the on-time control signal CTon2. After generating the switching control signals PWM1 and PWM2, the NOT gate 1552_3 receives the switching control signal PWM1 and outputs the switching control signal PWM1N based on the switching control signal PWM1. The NOT gate 1552_4 receives the switching control signal PWM2 and outputs the switching control signal PWM2N based on the switching control signal PWM2. The AND gate 1552_5 receives the switching control signal PWM1N and the switching control signal PWM2 and outputs the switching control signal PWM1N_2 based on the switching control signal PWM1N and the switching control signal PWM2. The AND gate 1552_6 receives the switching control signal PWM1 and the switching control signal PWM2N and outputs the switching control signal PWM2N_1 based on the switching control signal PWM1 and the switching control signal PWM2N.

Although not shown in FIG. 5, in one embodiment, at least one delay time period is set by a digital register. When the switching control signal PWM1 enters the second state, the switching control signal PWM1N is then controlled to be in the first state after a first delay time period, and when the switching control signal PWM2 enters the second state, the switching control signal PWM2N is then controlled to be in the first state after the first delay time period. Likewise, when the switching control signal PWM1N enters the second state, the switching control signal PWM1 may be then controlled to be in the first state after the first delay time period or a second delay time period, and when the switching control signal PWM2N enters the second state, the switching control signal PWM2 may be then controlled to be in the first state after the first delay time period or the second delay time period.

The switching converter 100 may receive an input voltage Vin of 40 V to 60 V and provide an output voltage Vout of 12 V. According to one embodiment of the present disclosure, the input voltage Vin and the output voltage Vout satisfy the following relation as shown in the following equation (3) below, wherein D is a duty ratio.

$$V out = V i n / {2}^{*} D \qquad ( 3 )$$

According to the equation above, if the output voltage Vin is 12V, the duty ratio D is larger than 0.5 when the output voltage is in a range of 40-48V, and the duty ratio D is smaller than 0.5 when the output voltage is in a range of 48-60V.

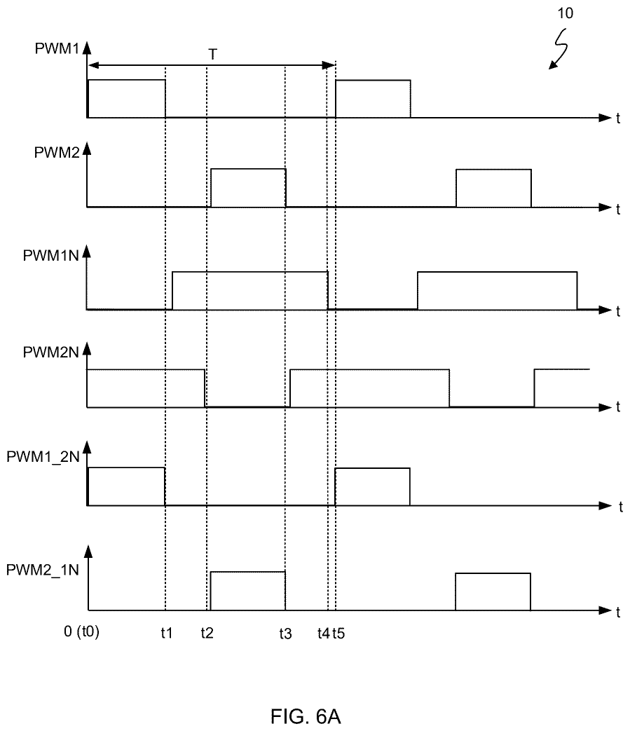

According to an embodiment of the present disclosure, the switching control signals for controlling the switches M1-M6 of the switching converter 100 have different signal waveforms with the duty ratio D smaller than 0.5 and with the duty ratio D larger than 0.5. FIG. 6A shows waveforms 10 of switching control signals generated by the controller 150 with a duty ratio D smaller than 0.5 in accordance with an embodiment of the present disclosure. FIG. 6B shows waveforms 20 of the switching control signals generated by the controller 150 with the duty ratio D larger than 0.5 in accordance with an embodiment of the present disclosure. In the embodiment shown in FIGS. 6A and 6B, when the switching control signals PWM1, PWM2, PWM1N, PWM2N, PWM1_2N, PWM2_1N are at a high voltage level, the corresponding switches are turned on, and when the switching control signals PWM1, PWM2, PWM1N, PWM2N, PWM1_2N, PWM2_1N are at a low voltage level, the corresponding switches are turned off.

The waveforms shown in FIGS. 6A and 6B are, from top to bottom, the switching control signal PWM1 for controlling the switch M1, the switching control signal PWM2 for controlling the switch M5, the switching control signal PWM1N for controlling the switch M4, the switching control signal PWM2N for controlling the switch M3, the switching control signal PWM1_2N for controlling the switch M6, and the switching control signal PWM2_1N for controlling the switch M2.

In the embodiment of FIG. 6A, the horizontal axis represents time, and a time period between a time to and a time t5 is one switching period T of the switching converter 100. At the time to, the switching control signals PWM1, PWM2N, PWM1_2N are turned from the low voltage level to the high voltage level by the controller 150 based on the output voltage Vout. At a time t1, the switching control signals PWM1 and PWM1_2N are turned from the high voltage level to the low voltage level by the controller 150, and after a delay, the switching control signal PWM1N is turned from the low voltage level to the high voltage level. At a time t2, the controller 150 turns the switching control signal PWM2N from the high voltage level to the low voltage level based on the output voltage Vout. After a delay time period, the controller 150 further turns the switching control signals PWM2 and PWM2_1N from the low voltage level to the high voltage level. At a time t3, the controller 150 turns the switching control signals PWM2 and PWM2_1N from the high voltage level to the low voltage level based on the output voltage Vout. After a delay time period, the controller 150 further turns the switching control signal PWM2N from the low voltage level to the high voltage level. At a time t4, the controller 150 turns the switching control signal PWM1N from the high voltage level to the low voltage level based on the output voltage Vout. After a delay time period, at a time t5, the controller 150 turns the switching control signals PWM1 and PWM1_2N from the low voltage level to the high voltage level.

In the embodiment shown in FIG. 6B, the horizontal axis represents time, and a time period between the time to to the time t4 corresponds to the switching cycle T of the switching converter 100. At the time to, the controller 150 turns the switching control signal PWM1 from the low voltage level to the high voltage level based on the output voltage Vout. After a delay time period, the controller 150 further turns the switching control signals PWM2N and PWM1_2N from the low voltage level to the high voltage level. At the time t1, the controller 150 turns the switching control signals PWM2N and PWM1_2N from the high voltage level to the low voltage level based on the output voltage Vout. After a delay time period, the controller 150 further turns the switching control signal PWM2 from the low voltage level to the high voltage level. At the time t2, the controller 150 turns the switching control signals PWM1N and PWM2_1N from the low voltage level to the high voltage level based on the output voltage Vout. At the time t3, the controller 150 turns the switching control signals PWM1N and PWM2_1N from the high voltage level to the low voltage level based on the output voltage Vout. After a delay time period, at the time t4, the controller 150 turns the switching control signal PWM1 from the low voltage level to the high voltage level.

In the embodiments shown in FIGS. 6A and 6B, the delay time periods before or after transition of each switching control signal between the high voltage level and the low voltage level may be intervals of a same length or different lengths. As shown in FIGS. 5, 6A, and 6B, the controller 150 adjusts the switching control signals PWM1, PWM2, PWM2N, and PWM2N_1 based on the output voltage Vout. Therefore, the switch M3 is turned on when the switch M5 is turned off, the switch M2 is turned off when at least one of the switches M1 and M3 is turned on, and the switch M2 is turned on when both the switches M1 and M3 are turned off. Similarly, the controller 150 adjusts the switching control signals PWM1, PWM1N, PWM2, and PWM1N_2 based on the output voltage Vout. Therefore, the switch M4 is turned on when the switch M1 is turned off, the switch M6 is turned off when at least one of switches M4 and M5 is turned on, and the switch M6 is turned on when both the switches M4 and M5 are turned off.

Additionally, as shown in FIGS. 5 and 6A, when the output voltage is 12V and the input voltage is from 48V to 60V (i.e., the duty cycle D is smaller than 0.5), the switching control signal PWM1 has the same waveforms with the switching control signal PWM1_2N, and the switching control signal PWM2 has the same waveforms with the switching control signal PWM2_1N. Therefore, according to one embodiment of the present disclosure, when the output voltage is 12V and the input voltage is from 48V to 60V (i.e., the duty cycle D is smaller than 0.5), the controller 150 turns on and off the switches M1 and M6 based on the switching control signal PWM1, and turns on and off the switches M2 and M5 based on the switching control signal PWM2.

Similarly, as shown in FIGS. 5 and 6B, when the output voltage is 12V and the input voltage is from 40V to 48V (i.e., the duty cycle D is larger than 0.5), the switching control signal PWM1N has the same waveforms with the switching control signal PWM2_1N, and the switching control signal PWM2N has the same waveforms with the switching control signal PWM1_2. Therefore, according to one embodiment of the present disclosure, when the output voltage is 12V and the input voltage is from 40V to 48V (i.e., the duty cycle D is larger than 0.5), the controller 150 turns on and off the switches M2 and M4 based on the switching control signal PWM1N, and turns on and off the switches M3 and M6 based on the switching control signal PWM2N.

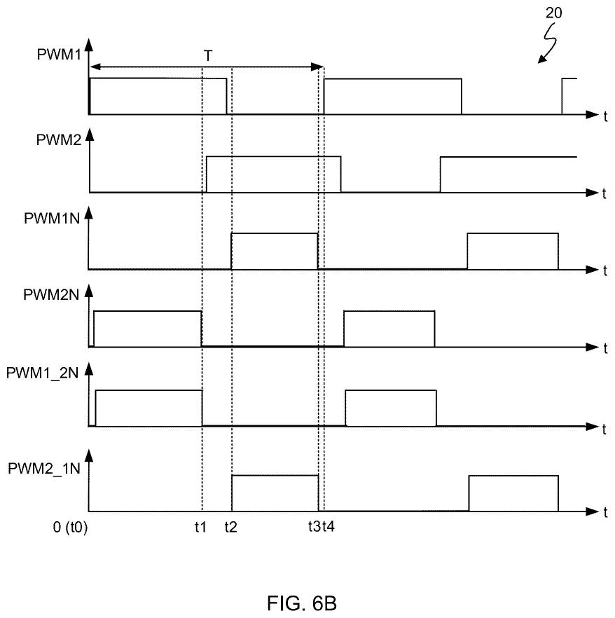

The following will describe a switching converter 200 according to one embodiment of the present disclosure with reference to FIGS. 7-11. It is to be noted that some circuit parts of the switching converter 200 are same with those of the switching converter 100, which will not be illustrated here for brevity.

FIG. 7 schematically shows a circuit diagram of the switching converter 200 in accordance with an embodiment of the present disclosure. Compared with the switching converter 100 shown in FIG. 1, in the embodiment of FIG. 7, the switching converter 200 has only one flying capacitor Cfly1, and the switching circuit 220 has only one switch M4. In one embodiment, the switch circuit 210 has the switches M1, M2, and M3 coupled in series, while the switching circuit 220 has only switch M4. Each of the switches M1-M3 and the flying capacitor Cfly1 has a first terminal and a second terminal. In the embodiment of FIG. 7, the switches M1, M2, and M3 are still coupled in series between the input voltage terminal 101 and the reference ground. The first terminal of switch M1 is coupled to the output voltage terminal 101, the second terminal of the switch M1 is coupled to the first terminal of the switch M2 to form the intermediate node mid1, the second terminal of the switch M2 is coupled to the first terminal of the switch M3 to form the switch node sw1. The first terminal of the flying capacitor Cfly1 is coupled to the intermediate node mid1, and the second terminal is coupled to the first terminal of the switch M4. The second terminal of the switch M4 is coupled to the reference ground. The inductors L10 and L20 are coupled in series between the switch node sw1 and the first terminal of the switch M4.

In addition to the above differences, another difference between the embodiment of FIG. 7 and that of FIG. 1 is that in the embodiment of FIG. 7, a controller 250 provides a switching control signal PWM1 at the control signal output pin P5 for controlling the switches M1 and M3, and provides a switching control signal PWM2 at the control signal output pin P6 for controlling the switches M2 and M4.

Similar to the embodiment of FIG. 1, in the embodiment of FIG. 7, the inductor L10 is shown in the form of the inductance value L1 and the DC resistance (i.e., DCR) DCR1 coupled in series, and the inductor L20 is shown in the form of the inductance value L2 and the DC resistance DCR2 coupled in series. The second terminal of the inductor L10 and the first terminal of the inductor L20 are non-dotted terminals, which are coupled together. The sensing capacitor C1 and the sensing resistor Rs1 are coupled in series between the first and second terminals of the inductor L10. The current sense circuit 230 is coupled in parallel with the sensing capacitor C1 and provides a current sensing signal CS1, which represents the current flowing through the DC resistance DCR1 of the inductor L10. Similarly, the sensing capacitor C2 and the sensing resistor Rs2 are coupled in series between the first and second terminals of the inductor L20. The current sense circuit 240 is coupled in parallel with the sensing capacitor C2 and provides the current sensing signal CS2, which represents the current flowing through the DC resistance DCR2 of the inductor L20. In one embodiment, the current sense circuit 230 comprises the adjustment resistor R1, a current mirror driving circuit 231, and a mirror current circuit 232. The current mirror driving circuit 231 senses the current flowing through the sensing resistor Rs1 and provides the current driving signal Idr1. The mirror current circuit 232 receives the current driving signal Idr1 and provides the current sensing signal CS1. Similarly, the current sense circuit 240 comprises the adjusting resistor R2, the current mirror driving circuit 241, and the mirror current circuit 242. The current mirror driving circuit 241 senses the current flowing through the sensing resistor Rs2 and generates the current driving signal Idr2. The mirror current circuit 242 receives the current driving signal Idr2 and provides the current sensing signal CS2, which represents the current flowing through the DC resistance DCR2 of the inductor L20.

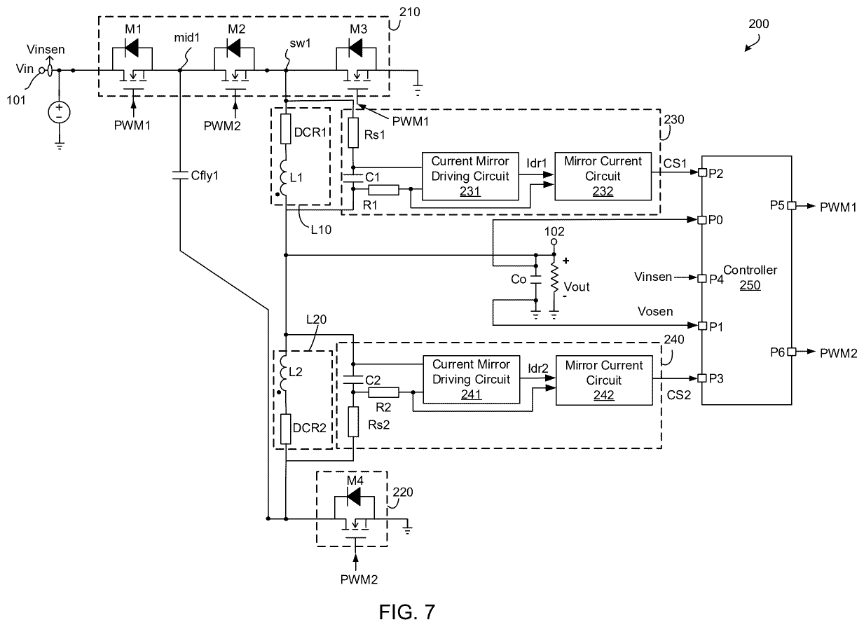

FIG. 8 schematically shows a circuit diagram of the current sense circuit 230 of the switching converter 200 in accordance with an embodiment of the present disclosure. Generation of the current sensing signals CS1 and CS2 is described below by taking the current sense circuit 230 as an example since the current sensing signal CS1 and the current sensing signal CS2 are respectively generated by the current sense circuit 230 and the current sense circuit 240 in the same way.

As shown in FIG. 8, the current mirror driving circuit 231 has the sensing capacitor C1, the sensing resistor Rs1, the adjusting resistor R1, a voltage regulation circuit 233, and the operational amplifier AMP1. The sensing capacitor C1 and the sensing resistor Rs1 are coupled in series between the first terminal and second terminal of the inductor L10. The adjusting resistor R1 has a first terminal and a second terminal, wherein the first terminal of the adjusting resistor R1 is coupled to the current mirror driving circuit 231 and the mirror current circuit 232, while the second terminal of the adjusting resistor R1 is coupled to the second terminal of the sensing capacitor C1. The voltage regulation circuit 233 has a voltage input terminal 2331, a voltage input terminal 2332, a voltage output terminal 2333, the balancing resistor Rb1, the voltage dividing resistors R11 and R12, and the Zener diode ZD1. The mirror current circuit 232 comprises the transistor Q1 and a current mirror 234. The current mirror 234 has an input terminal coupled to the voltage regulation circuit 233, and further has a first terminal 2341 and a second terminal 2342. The voltage regulation circuit 233 supplies power to the positive power supply terminal of the operational amplifier AMP1 through its voltage output terminal 2333, while the negative power supply terminal of the operational amplifier AMP1 receives the output voltage Vout from the output voltage terminal 102. Therefore, the operational amplifier AMP1 is configured to maintain the voltage difference (e.g., 5V) between the positive power supply terminal and the negative power supply terminal of the operational amplifier AMP1. According to one embodiment of this disclosure, the first voltage provided at the voltage output terminal 2333 of the voltage regulation circuit 233 may be 17V. One with ordinary skill in the art should understand that other types of circuits may also be used to power the operational amplifier AMP1 and maintain the voltage difference between its positive and negative power supply terminals. The operational amplifier AMP1 senses the current flowing through the sensing resistor Rs1 and generates the current driving signal Idr1, and then provides the current driving signal Idr1 from the output terminal of the operational amplifier AMP1 to the base of the transistor Q1. The current driving signal Idr1 is configured to drive the transistor Q1 so that the transistor Q1 works in the linear amplification region, enabling the current mirror 234 to provide a mirrored current as the current sensing signal CS1 based on the current flowing through the adjusting resistor R1. The current sensing signal CS1 represents the current flowing through the DC resistance DCR1 of the inductor L10 according to the equation (1).

In prior art, for current sensing in a switching converter, a voltage sensing signal are typically provided to the controller first, and then the controller converts the voltage sensing signal into a current sensing signal. However, the maximum withstand voltage of the pins of the controller is generally around 4V, thus the current sensing methods in prior art fail to meet the requirements for switching converters with an output voltage of 12V. The current sensing method according to one embodiment of the present inventio overcomes the limitation of the maximum withstand voltage of the controller pins since there is no need for a voltage sensing step.

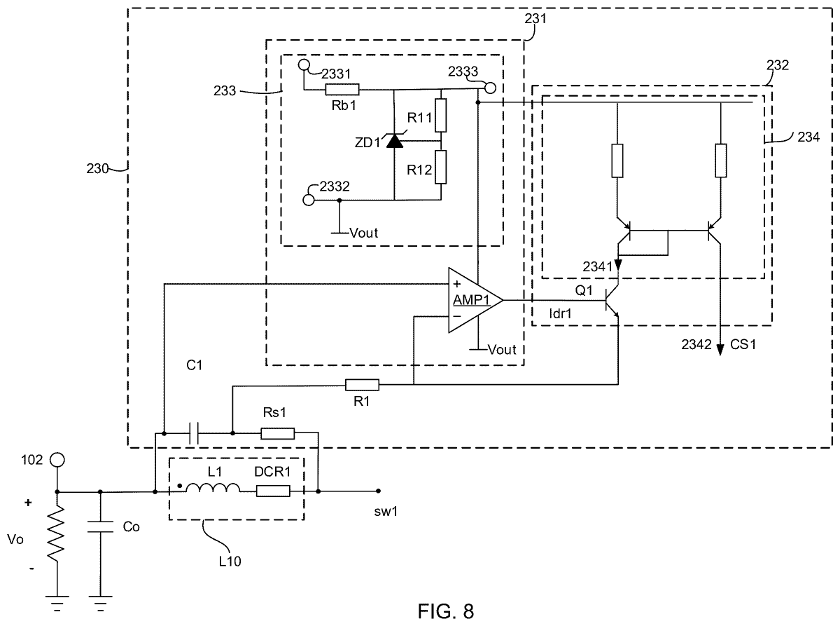

FIG. 9 schematically shows a circuit diagram of the controller 250 of the switching converter 200 in accordance with an embodiment of the present disclosure. As shown in FIG. 9, the controller 250 comprises a current processing circuit 251, a differential amplifier 252, a comparison circuit 253, an on-time circuit 254, and a switching control circuit 255.

Compared with the controller 150 shown in FIG. 3, the controller 250 shown in FIG. 9 generates the switching control signal PWM1 for controlling the switches M1 and M3 of the switching circuit 210 based on the output voltage Vout, and generates the switching control signal PWM2 for controlling the switches M2 and M4 of the switching circuit 210 based on the output voltage Vout. In one embodiment, the switching control circuit 255 of the controller 250 provides the switching control signals PWM1 and PWM2 based on the comparison signal SC and the on-time control signals CTon1 and CTon2.

In one embodiment, the switching control circuit 255 adjusts the switching control signal PWM1 based on at least one of the comparison signal SC and the on-time control signal CTon1 to control the switches M1 and M3 to switch between the first state and a second state, for example, the switches M1 and M3 are turned on when the switches M2 and M4 are kept off, and the switches M1 and M3 are turned off after a time period of the switches M1 and M3 being on is equal to the time period Ton1. The switching control circuit 255 adjusts the switching control signal PWM2 based on at least one of the comparison signal SC and the on-time control signal CTon2 to control the switches M2 and M4 to switch between the first state and the second state, for example, the switches M2 and M4 are turned on when the switches M1 and M3 are kept off, and the switches M2 and M4 are turned off after a time period of the switches M2 and M4 being on is equal to the time period Ton2.

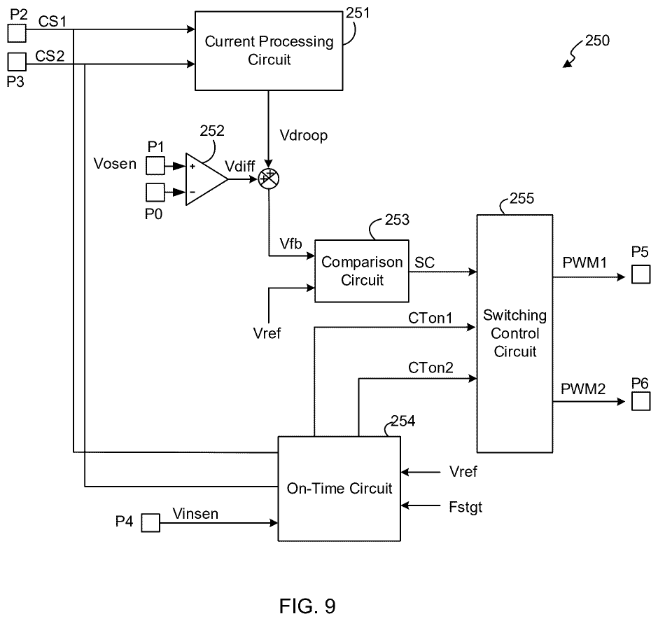

FIG. 10 schematically shows a circuit diagram of the switching control circuit 255 of the switching converter 200 in accordance with an embodiment of the present disclosure. In the embodiment of FIG. 10, the switching control circuit 255 comprises a frequency dividing circuit 2551 and a control signal generation circuit 2552.

The frequency dividing circuit 2551 provides the frequency dividing signals SC1 and SC2 based on the comparison signal SC. The comparison signal SC is generated by the comparison circuit 253 based on the voltage feedback signal Vfb (which represents the output voltage Vout) and the reference signal Vref. In one embodiment, a logic circuit 2553_1 generates the set signal SET1 based on the frequency dividing signal SC1 to switch the switching control signal PWM1 to its first state. Similarly, a logic circuit 2553_2 generates a set signal SET2 based on the divided signal SC2 to switch the switching control signal PWM2 to its first state.

The control signal generation circuit 2552 comprises a first control signal generator 2552_1 and a second control signal generator 2552_2. The first control signal generator 2552_1 generates the switching control signal PWM1 for controlling the switches M1 and M3 based on the comparison signal SC and the on-time control signal CTon1. Similarly, the second control signal generator 2552_2 generates the switching control signal PWM2 for controlling the switches M2 and M4 based on the comparison signal SC and the on-time control signal CTon2.

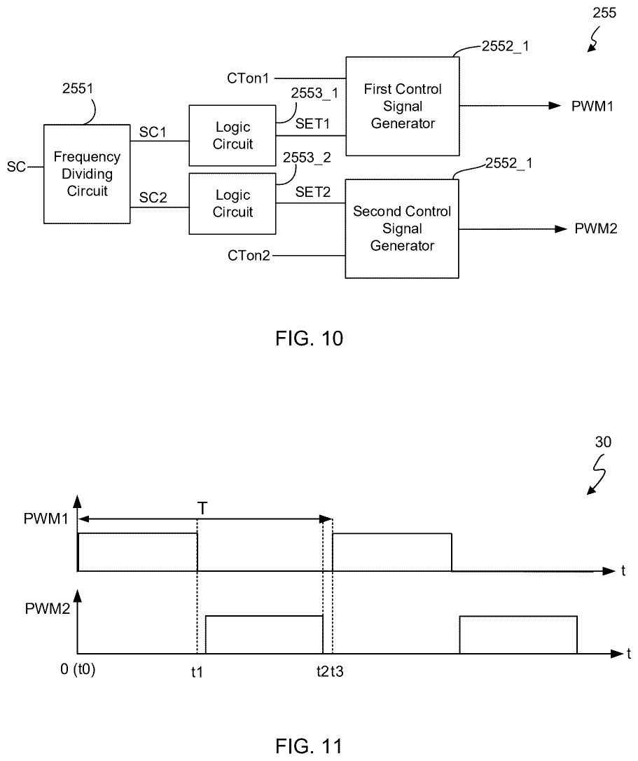

FIG. 11 shows waveforms 30 of the switching control signals generated by the controller 250 in accordance with an embodiment of the present disclosure. In other words, FIG. 11 shows the waveforms 30 of the switching control signals PWM1 and PWM2 in accordance with an embodiment of the present disclosure. In the embodiment of FIG. 11, the horizontal axis represents time, and a time period between the time to and the time t3 is the switching period T of the switching converter 200. The switching control signals PWM1 and PWM2 turn corresponding switches on when at the high voltage level, and turn the corresponding switches off when at the low voltage level. At the time to, the controller 250 turns the switching control signal PWM1 from the low voltage level to the high voltage level based on the output voltage Vout. At the time t1, the controller 250 turns the switching control signal PWM1 from the high voltage level to the low voltage level based on the output voltage Vout and further turns the switching control signal PWM2 from the low voltage level to the high voltage level after a delay time period. At the time t2, the controller 250 turns the switching control signal PWM2 from the high voltage level to the low voltage level based on the output voltage Vout and further turns the switching control signal PWM1 from the low voltage level to the high voltage level after the delay time period.

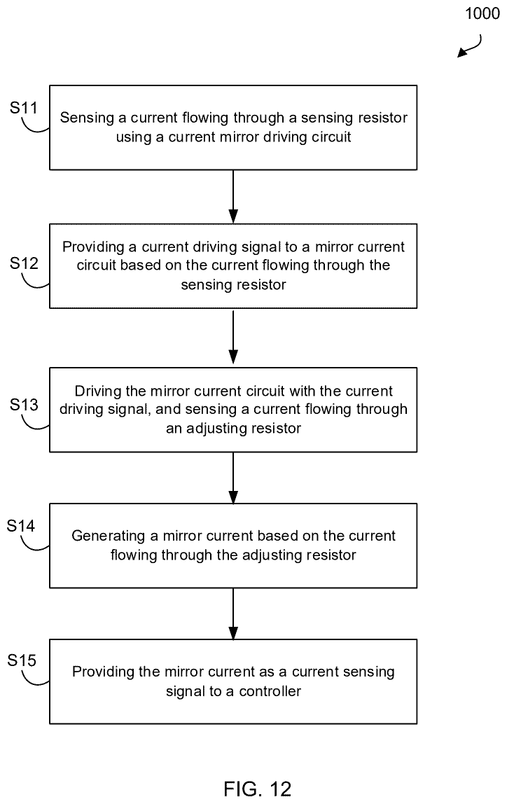

FIG. 12 illustrates a current sense method 1000 for a switching converter in accordance with an embodiment of the present disclosure. The current sense method 1000 can be used for the switching converters as shown in FIG. 1 and FIG. 7. As previously mentioned, the switching converter comprises at least one controllable switch and an inductor, and may also comprise one or more sensing capacitors and sensing resistors. By turning on and off the at least one controllable switch, the inductor is charged and discharged to convert the input voltage Vin into the output voltage Vout. The current sense method 1000 comprises steps S11-S15.

In step S11, sensing a current flowing through a sensing resistor using a current mirror driving circuit.

In step S12, providing a current driving signal to a mirror current circuit based on the current flowing through the sensing resistor.

In step S13, driving the mirror current circuit with the current driving signal, and sensing a current flowing through an adjusting resistor.

In step S14, generating a mirror current based on the current flowing through the adjusting resistor.

In step S15, providing the mirror current as a current sensing signal to a controller.

Note that in the current sense method 1000 described above, the functions indicated in the boxes can also occur in a different order than those shown in FIG. 12. Besides, some of the steps (e.g., the step S15) may be omitted, other steps may also be included in the current sense method 1000.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

What is claimed is:

1. A switching converter, comprising:
an input voltage terminal capable of receiving an input voltage;
an output voltage terminal capable of providing an output voltage;
a first switching circuit, comprising a first switch, a second switch and a third switch, each of the first switch, the second switch, and the third switch having a first terminal and a second terminal, wherein the first terminal of the first switch is coupled to the input voltage terminal, the second terminal of the first switch is coupled to the first terminal of the second switch to form a first intermediate node, the second terminal of the second switch is coupled to the first terminal of the third switch to form a first switch node, and the second terminal of the third switch is coupled to a reference ground;
a first flying capacitor, having a first terminal and a second terminal, wherein the first terminal of the flying capacitor is coupled to the first intermediate node;
a second switching circuit, comprising a fourth switch, the fourth switch having a first terminal and a second terminal, wherein the first terminal of the fourth switch is coupled to the second terminal of the first flying capacitor, and the second terminal of the fourth switch is coupled to the reference ground;
a first inductor and a second inductor, each of the first inductor and the second inductor having a first terminal and a second terminal, wherein the first terminal of the first inductor is coupled to the first switch node, the second terminal of the first inductor and the first terminal of the second inductor are coupled together and both coupled to the output voltage terminal, and the second terminal of the second inductor is coupled to the first terminal of the fourth switch, and wherein the second terminal of the first inductor and the first terminal of the second inductor are non-dotted terminals;
a first current sense circuit, capable of providing a first current sensing signal based on a current flowing through the first inductor;
a second current sense circuit, capable of providing a second current sensing signal based on a current flowing through the second inductor; and
a controller, capable of generating a droop voltage signal based on the first current sensing signal and the second current sensing signal, and providing a first switching control signal, a second switching control signal, a third switching control signal, and a fourth switching control signal respectively for controlling the first switch, the second switch, the third switch, and the fourth switch based on the first current sensing signal, the second current sensing signal, the output voltage, the droop voltage signal, and a reference signal.

2. The switching converter of claim 1, wherein the first current sense circuit comprises:
a first sensing capacitor and a first sensing resistor coupled in series between the first terminal and the second terminal of the first inductor, wherein a first terminal of the first sensing resistor and a first terminal of the first sensing capacitor are coupled together to form a common terminal of the first sensing resistor and the first sensing capacitor;
a first adjusting resistor, having a first terminal and a second terminal, wherein the second terminal of the first adjusting resistor is coupled to a second terminal of the first sensing capacitor;
a first current mirror driving circuit, coupled to the common terminal of the first sensing resistor and the first sensing capacitor, wherein the first current mirror driving circuit is capable of providing a first current driving signal; and
a first mirror current circuit, capable of receiving the first current driving signal and providing the first current sensing signal based on a current flowing through the first adjusting resistor, wherein the first terminal of the first adjusting resistor is further coupled to the first mirror current circuit.

3. The switching converter of claim 2, wherein the first current mirror driving circuit further comprises:
a voltage regulation circuit having a first voltage input terminal, a second voltage input terminal, and a voltage output terminal, wherein the voltage regulation circuit is capable of receiving the input voltage at the first voltage input terminal and receiving the output voltage at the second voltage input terminal, and is further capable of providing a first voltage at the voltage output terminal based on the output voltage; and
an operational amplifier, wherein a negative power supply terminal of the operational amplifier is coupled to the output voltage terminal, and a positive power supply terminal of the operational amplifier is coupled to the voltage output terminal of the voltage regulation circuit to receive the first voltage, a non-inverting input terminal of the operational amplifier is coupled to the common terminal of the first sensing resistor and the first sensing capacitor, an inverting input terminal of the operational amplifier is coupled to the first terminal of the first adjusting resistor, and an output terminal of the operational amplifier is capable of providing the first current sensing signal; wherein
the first voltage is larger than the output voltage, and a voltage difference between the first voltage and the output voltage has a difference with a maximum pin voltage of the controller of smaller than 2V.

4. The switching converter of claim 2, wherein the first mirror current circuit further comprises:
a current mirror, having a first terminal and a second terminal, wherein the current mirror is capable of providing the first current sensing signal at its second terminal based on a current flowing through its first terminal; and
a transistor, having a control terminal, a first terminal, and a second terminal, wherein the control terminal of the transistor is capable of receiving the current driving signal, the first terminal of the transistor is coupled to the first terminal of the current mirror, and the second terminal of the transistor is coupled to the first terminal of the first adjusting resistor.

5. The switching converter of claim 1, wherein the second current sense circuit comprises:
a second sensing capacitor and a second sensing resistor coupled in series between the first terminal and the second terminal of the second inductor, wherein a first terminal of the second sensing resistor and a first terminal of the second sensing capacitor are coupled together to form a common terminal of the second sensing resistor and the second sensing capacitor;
a second adjusting resistor, having a first terminal and a second terminal, wherein the second terminal of the second adjusting resistor is coupled to a second terminal of the second sensing capacitor;
a second current mirror driving circuit, coupled to the common terminal of the second sensing resistor and the second sensing capacitor, wherein the second current mirror driving circuit is capable of providing a second current driving signal; and
a second mirror current circuit, capable of receiving the second current driving signal and providing the second current sensing signal based on a current flowing through the second adjusting resistor, wherein the first terminal of the second adjusting resistor is further coupled to the second mirror current circuit.

6. The switching converter of claim 1, wherein the second switching circuit further comprises:
a fifth switch and a sixth switch, each of the fifth switch and the sixth switch having a first terminal and a second terminal, wherein the first terminal of the fifth switch is coupled to the input voltage terminal, the second terminal of the fifth switch is coupled to the first terminal of the sixth switch to form a second intermediate node, and the second terminal of the sixth switch is coupled to the first terminal of the fourth switch; wherein
the controller is capable of providing a fifth switching control signal for controlling the fifth switch and a sixth switching control signal for controlling the sixth switch based on the first current sensing signal, the second current sensing signal, the output voltage, the droop voltage signal, and the reference signal.

7. The switching converter of claim 6, wherein:
the controller is configured to turn on the first switch based on the first switching control signal in response to the fourth switch being off, and is further configured to turn off the first switch in response to that a time period of the first switch being on is equal to a first time period;
the controller is configured to turn on the fifth switch based on the fifth switching control signal in response to the third switch being off, and is further configured to turn off the fifth switch in response to that a time period of the fifth switch being on is equal to a second time period; and wherein
the controller is further capable of adjusting the first time period and the second time period based on the input voltage, the first current sense signal, and the second current sense signal.

8. The switching converter of claim 6, wherein:
the controller is further capable of providing the second switching control signal, the third switching control signal, the fourth switching control signal, and the sixth switching control signal based on the first switching control signal and the fifth switching control signal;
the controller is further capable of turning on the third switch in response to the fifth switch being off, turning off the second switch in response to at least one of the first switch and the third switch being on, and turning on the second switch in response to both the first switch and the third switch being off based on the first switching control signal, the second switching control signal, the third switching control signal and the fifth switching control signal; and wherein
the controller is further capable of turning on the fourth switch in response to the first switch being off, turning off the sixth switch in response to at least one of the fourth and fifth switch being on, and turning on the sixth switch in response to both the fourth and fifth switch being off based on the first switching control signal, the fourth switching control signal, the fifth switching control signal and the sixth switching control signal.

9. The switching converter of claim 1, wherein:
the controller is configured to turn on the first switch and the third switch based on the first switching control signal in response to the second switch and the fourth switch being off, and is further configured to turn off the first switch in response to that a time period of the first switch being on is equal to a first time period and turn off the third switch in response to that a time period of the third switch being on is equal to the first time period;
the controller is further configured to turn on the second switch and the fourth switch based on the second switching control signal in response to the first switch and the third switch being off, and is further configured to turn off the second switch in response to that a time period of the second switch being on is equal to a second time period and turn off the fourth switch in response to that a time period of the fourth switch being on is equal to the second time period; and wherein
the controller is further capable of adjusting the first time period and the second time period based on the input voltage, the first current sensing signal, and the second current sensing signal.

10. A switching converter, comprising a first switching circuit, a second switching circuit, a first inductor and a second inductor negatively coupled with each other, a first current sense circuit, a second current sense circuit, and a controller, wherein the controller comprises:
an output voltage sensing pin, capable of receiving an output voltage sensing signal representing an output voltage of the switching converter;
an input voltage sensing pin, capable of receiving an input voltage sensing signal representing an input voltage of the switching converter;
a first current sensing pin, capable of receiving a first current sensing signal provided by the first current sense circuit, wherein the first current sensing signal represents a current flowing through the first inductor;
a second current sensing pin, capable of receiving a second current sensing signal provided by the second current sense circuit, wherein the second current sensing signal represents a current flowing through the second inductor;
a first control signal output pin, capable of providing a first switching control signal to control a first switch of the first switching circuit;
a second control signal output pin, capable of providing a second switching control signal to control a second switch of the first switching circuit;
a third control signal output pin, capable of providing a third switching control signal to control a third switch of the first switching circuit, wherein the first switch, the second switch, and the third switch are coupled in series between an input terminal for receiving the input voltage of the switching converter and a reference ground;
a fourth control signal output pin, capable of providing a fourth switching control signal to control a fourth switch of the second switching circuit;
a fifth control signal output pin, capable of providing a fifth switching control signal to control a fifth switch of the second switching circuit; and
a sixth control signal output pin, capable of providing a sixth switching control signal to control a sixth switch of the second switching circuit, wherein the fourth switch, the fifth switch, and the sixth switch are coupled in series between the input terminal of the switching converter and the reference ground; wherein
the first current sense circuit comprises a first sensing capacitor and a first sensing resistor coupled in series between the first terminal and the second terminal of the first inductor, and the second current sense circuit comprises a second sensing capacitor and a second sensing resistor coupled in series between the first terminal and the second terminal of the second inductor;
the first current sense circuit is capable of generating a first current driving signal based on sensing a current flowing through the first sensing resistor and providing the first current sensing signal based on the first current driving signal, and the second current sense circuit is capable of generating a second current driving signal based on sensing a current flowing through the second sensing resistor and providing the second current sensing signal based on the second current driving signal; and
the controller is capable of turning on the first switch by adjusting the first switching control signal based on the output voltage and turning on the fifth switch by adjusting the fifth switching control signal based on the output voltage, wherein the first switch is turned off in response to that a time period of the first switch being on is equal to a first time period, and the fifth switch is turned off in response to that a time period of the fifth switch being on is equal to a second time period, and wherein the controller is further capable of adjusting the first time period and the second time period based on the input voltage, the first current sense signal, and the second current sense signal.

11. The switching converter of claim 10, wherein:
the first current sense circuit further comprises a first adjusting resistor, a first current mirror driving circuit, and a first mirror current circuit, the first adjusting resistor having a first terminal and a second terminal, wherein the first terminal of the first adjusting resistor is coupled to the first current mirror driving circuit and the first mirror current circuit, and the second terminal of the first adjusting resistor is coupled to the first sensing capacitor;
the first current mirror driving circuit is capable of providing the first current driving signal based on sensing the current flowing through the first sensing resistor, and the first mirror current circuit is capable of receiving the first current driving signal and providing the first current sensing signal based on sensing a current flowing through the first adjusting resistor;
the second current sense circuit further comprises a second adjusting resistor, a second current mirror driving circuit, and a second mirror current circuit, the second adjusting resistor having a first terminal and a second terminal, wherein the first terminal of the second adjusting resistor is coupled to the second current mirror driving circuit and the second mirror current circuit, and the second terminal of the second adjusting resistor is coupled to the second sensing capacitor; and wherein the second current mirror driving circuit is capable of providing the second current driving signal based on sensing the current flowing through the second sensing resistor, and the second mirror current circuit is capable of receiving the second current driving signal and providing the second current sensing signal based on sensing a current flowing through the second adjusting resistor.

12. The switching converter of claim 10, wherein the controller is further capable of turning on the third switch in response to the fifth switch being off, turning off the third switch in response to the fifth switch being on, turning off the second switch in response to at least one of the first switch and the third switch being on, and turning on the second switch in response to both the first switch and the third switch being off, based on the first switching control signal, the second switching control signal, the third switching control signal and the fifth switching control signal.

13. The switching converter of claim 10, wherein the controller is further capable of turning on the fourth switch in response to the first switch being off, turning off the fourth switch in response to the first switch being on, turning off the sixth switch in response to at least one of the fourth and fifth switch being on, and turning on the sixth switch in response to both the fourth and fifth switch being off, based on the first switching control signal, the fourth switching control signal, the fifth switching control signal and the sixth switching control signal.

14. The switching converter of claim 10, wherein:
in response to the input voltage and the output voltage satisfying a first relation, the controller is configured to control the first switch and the sixth switch based on the first switching control signal and control the second switch and the fifth switch based on the second switching control signal.

15. The switching converter of claim 10, wherein:
in response to the input voltage and the output voltage satisfying a second relation, the controller is configured to control the second switch and the fourth switch based on the second switching control signal and control the third switch and the sixth switch based on the third switching control signal.

16. The switching converter of claim 10, wherein the controller further comprises:
a comparison circuit, capable of providing a comparison signal based on the output voltage sensing signal and a reference signal;
an on-time circuit, capable of providing a first on-time control signal for controlling the first time period and a second on-time control signal for controlling the second time period based on the input voltage sensing signal, the first current sensing signal, and the second current sensing signal; and
a switching control circuit, capable of providing the first switching control signal based on the comparison signal and the first on-time control signal and providing the second switching control signal based on the comparison signal and the second on-time control signal.

17. A current sense circuit for a switching converter, the switching converter having a switch and an inductor, wherein the current sense circuit comprises:
a sensing capacitor and a sensing resistor coupled in series between a first terminal and a second terminal of the inductor, wherein a first terminal of the sensing resistor and a first terminal of the sensing capacitor are coupled together to form a common terminal of the sensing resistor and the sensing capacitor;
an adjusting resistor having a first terminal and a second terminal;
a current mirror driving circuit coupled to the first terminal of the adjusting resistor and the common terminal of the sensing resistor and the sensing capacitor, wherein the current mirror driving circuit is capable of providing a current driving signal based on sensing a current flowing through the sensing resistor, and wherein the second terminal of the adjusting resistor is coupled to a second terminal of the sensing capacitor; and
a mirror current circuit, capable of receiving the current driving signal and providing a current sensing signal based on a current flowing through the adjusting resistor, wherein the first terminal of the adjusting resistor is further coupled to the mirror current circuit.

18. The current sense circuit of claim 17, wherein the current mirror driving circuit further comprises:
an operational amplifier, wherein a negative power supply terminal of the operational amplifier is configured to receive an output voltage of the switching converter, a positive power supply terminal of the operational amplifier is configured to receive a first voltage which is larger than the output voltage of the switching converter, a non-inverting input terminal of the operational amplifier is coupled to the common terminal of the sensing resistor and the sensing capacitor, and an inverting input terminal of the operational amplifier is coupled to the first terminal of the adjusting resistor; wherein
the operational amplifier is capable of providing the current driving signal at an output terminal of the operational amplifier by sensing the current flowing through the sensing resistor.

19. The current sense circuit of claim 18, wherein the current mirror driving circuit further comprises:
a voltage regulation circuit having a first voltage input terminal, a second voltage input terminal, and a voltage output terminal, wherein the voltage regulation circuit is configured to receive an input voltage of the switching converter at the first voltage input terminal and receive the output voltage of the switching converter at the second voltage input terminal, and is further configured to provide a first voltage at the voltage output terminal based on the output voltage to maintain a voltage difference between the positive power supply terminal and the negative power supply terminal of the operational amplifier; wherein
the first voltage is larger than the output voltage of the switching converter.

20. The current sense circuit of claim 19, wherein the mirror current circuit comprises:
a transistor, having a control terminal, a first terminal, and a second terminal, wherein the control terminal of the transistor is coupled to the output terminal of the operational amplifier to receive the current driving signal, the second terminal of the transistor is coupled to the first terminal of the adjusting resistor and the inverting input terminal of the operational amplifier; and
a current mirror, having a first terminal and a second terminal, wherein the first terminal of the current mirror is coupled to the first terminal of the transistor, and the current mirror is capable of providing the current sensing signal at its second terminal based on a current flowing through its first terminal.
